(19) United States
(12) Patent Application Publication
(10) Pub. No.: US 2023/0077446 A1
(43) Pub. Date: Mar. 16, 2023

(54) SMART SEAMLESS SIGN LANGUAGE CONVERSATION DEVICE

(71) Applicant: International Business Machines Corporation, Armonk, NY (US)

(72) Inventors: Partho Ghosh, Kolkata (IN); Venkata Vara Prasad Karri, Visakhapatnam (IN); Preetha Ghosh, Kolkata (IN); Girish Padmanabhan, Pune (IN); Amit Kumar Senapaty, Visakhapatnam (IN)

(21) Appl. No.: 17/477,216

(22) Filed: Sep. 16, 2021

(51) Int. Cl. G06K 9/00; G06F 3/01; H04R 1/10; H04R 25/00; G06T 19/00

(52) U.S. Cl. CPC G06K 9/00355; G06F 3/015; H04R 1/1066; H04R 25/65; G06F 3/017; G06T 19/006; H04R 2460/13; H04R 2460/17

(57) ABSTRACT

An approach is disclosed that is performed by a pair of smart glasses worn by a user that includes an information handling system that includes a processor and a memory. The approach receives input cues at input components of the smart glasses. Input components include a digital camera that is included in the smart glasses and accessible by the processor, a microphone that is included in the smart glasses and accessible by the processor. The received cues are analyzed resulting in one or more output cues focused on assisting the user. These output cues are transmitted through one or more output components of the smart glasses. One of the output components is a display on the inside of a lens included in the smart glasses.

### BACKGROUND

There are 466 million people in the world with disabling hearing loss. This is over 5% of the world's population; 34 million of these people are children. There are different kind of impairments like, but not limited to, complete hearing loss, mid hearing loss, disabling hearing, permanent voice loss (by birth or in between due to thyroid or larynx cancer), and temporary voice loss. There are instances where they either go to same selected shops or stores for shopping. They either silently pick the same brand or product type because they cannot communicate to non SL parties without interpreters and because of lack of trained Interpreter the problem for SLC do worsen with each passing day. There are some existing solutions or feasible options but with variety of limitations.

### SUMMARY

An approach is disclosed that is performed by a pair of smart glasses worn by a user that includes an information handling system that includes a processor and a memory. The approach receives input cues at input components of the smart glasses. Input components include a digital camera that is included in the smart glasses and accessible by the processor, a microphone that is included in the smart glasses and accessible by the processor. The received cues are analyzed resulting in one or more output cues focused on assisting the user. These output cues are transmitted through one or more output components of the smart glasses. One of the output components is a display on the inside of a lens included in the smart glasses.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a depiction of a pair of smart glasses that are modified to provide a smart, seamless, sign language conversation device;

FIG. 4 is a depiction showing components used to provide a smart, seamless, sign language conversation device;

FIG. 5 is a depiction of a flowchart showing the logic used during a smart glass language conversation;

FIG. 6 is a depiction of a flowchart showing the logic used to analyze inputs and prepare outputs to and from the smart glasses;

FIG. 7 is a continuation of the flowchart showing the logic used to analyze inputs and prepare outputs to and from the smart glasses; and

FIG. 8 is a further continuation of the flowchart showing the logic used to analyze inputs and prepare outputs to and from the smart glasses.

### DETAILED DESCRIPTION

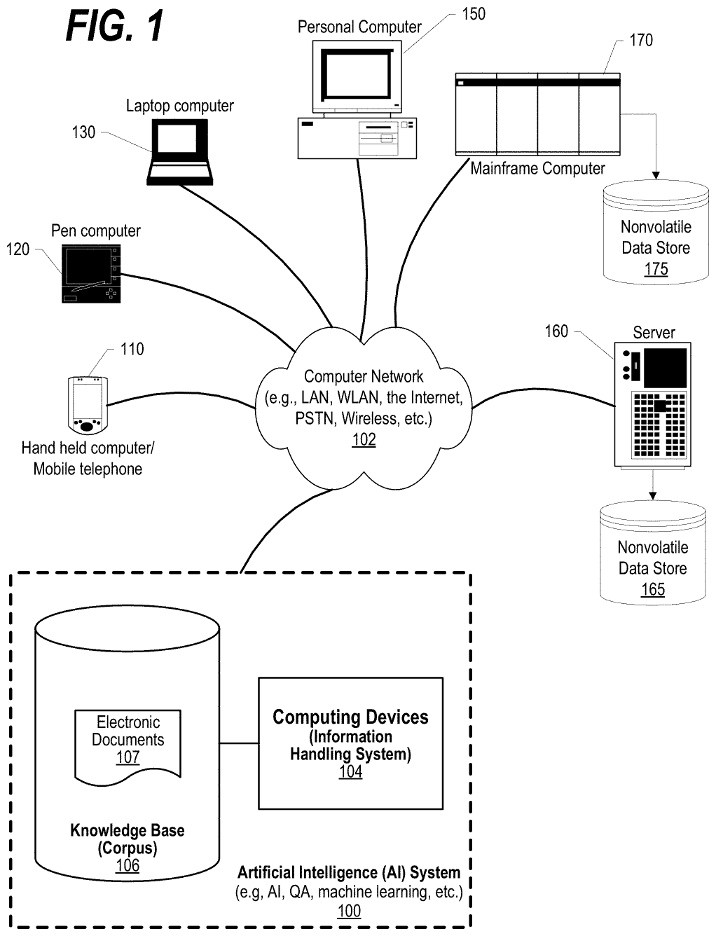

FIGS. 1-8 describe an approach to provide a smart, seamless sign language conversion device using a pair of specially equipped smart glasses. In this disclosure, various acronyms and phrases are used including “SLC”=Sign Language Community, “SLC Individual”=Sign Language Community Individual, “Strictly SLC Individual”=A Sign Language Individual who is only versed with Sign Language and not versed with corresponding Textual language, “Locale based SLC Individual”=A Sign Language Individual versed with only a particular Sign Language such as American or Indian or French, “SLC Communicator”=A Sign Language Individual trying to communicate, “SLC Responder”=A Sign Language Individual trying to respond, and “Non SLC Communicator”=A Non Sign Language Individual trying to communicate.

A few of the novel aspects of smart, seamless sign language conversion device using a pair of specially equipped smart glasses include the following: 1. User Experience: Spectacle are easier to carry and put on compared to a Sign Language Glove or a bot or a ring or an under-skin sensor; 2. Situational Experience: Imagine Listening to a Commentary, reading a Book, or reading a Traffic Instructions, Mobile based solutions are not seamless when driving or scanning during reading a book, etc.; 3. The current Ideas with respect to sign Language Lack of Natural Context, Individual voice/gesture, Situation based tone, existing solutions are plane robotic Sign Language converters; 4. Seamless Communication is not possible with mobile devices; 5. Dynamic seamless Communication between American SLC Individual and an Indian SLC; 6. Lack of seamless two-way communication between an SLC Communicator and a responder (SLC or Non SLC); 7. need for all-encompassing solution which benefits different SLC individuals on different situations; 8. When the sign language systems are designed, Digital Twins provide more better system and at real time AR/VR will provide real time data to improve product based on the available real users.

The majority of sign language involves only upper part of the body from upper waist level and upwards. Besides, the same sign can have considerably large changes in shapes when it is in different location in the sentence. Hand gestures can be categorized into several types such as: conversational gestures controlling gestures manipulative gestures communicative gestures.

FIG. 1 depicts a schematic diagram of one illustrative embodiment of artificial intelligence (AI) system 100 in a computer network 102. AI system 100 includes artificial intelligence computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable functionality, such as question/answer (QA) generation functionality, for one or more content users. Other embodiments of AI system 100 may be used with components, systems, sub-systems, and/or devices other than those that are depicted herein.

AI system 100 maintains knowledge base 106, also known as a “corpus,” which is a store of information or data that the AI system draws on to solve problems. This knowledge base includes underlying sets of facts, assumptions, models, and rules which the AI system has available in order to solve problems.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that artificial intelligence 100 may operate in environments of any size, including local and global, e.g., the Internet. Additionally, artificial intelligence 100 serves as a front-end system that can make available a variety of knowledge extracted from or represented in documents, network-accessible sources and/or structured data sources. In this manner, some processes populate the artificial intelligence with the artificial intelligence also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and, in one embodiment, may input questions to AI system 100 that may be answered by the content in the corpus of data. As further described below, when a process evaluates a given section of a document for semantic content, the process can use a variety of conventions to query it from the artificial intelligence.

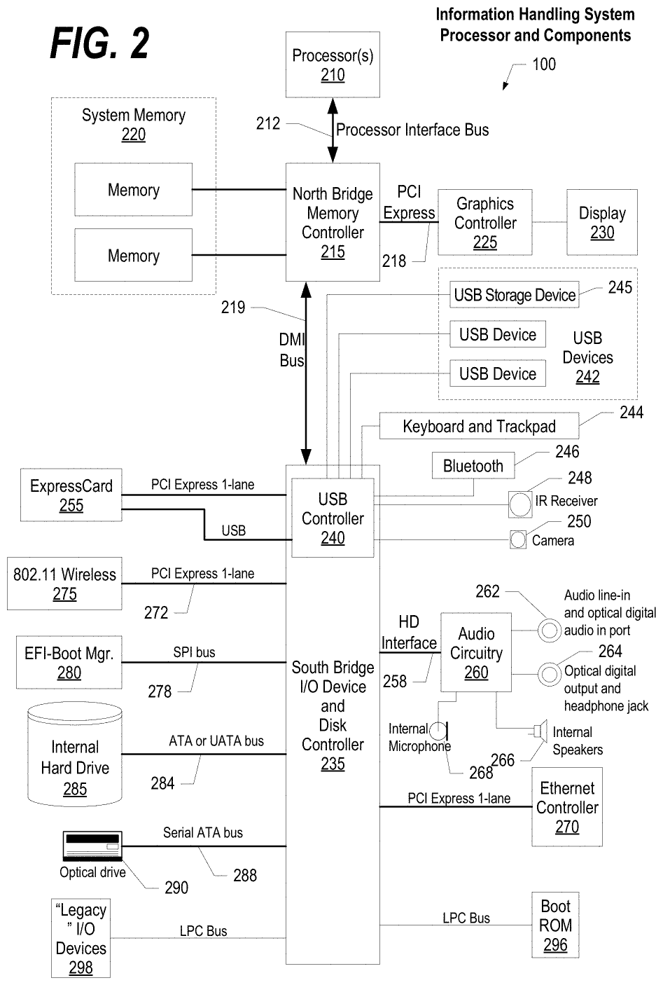

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

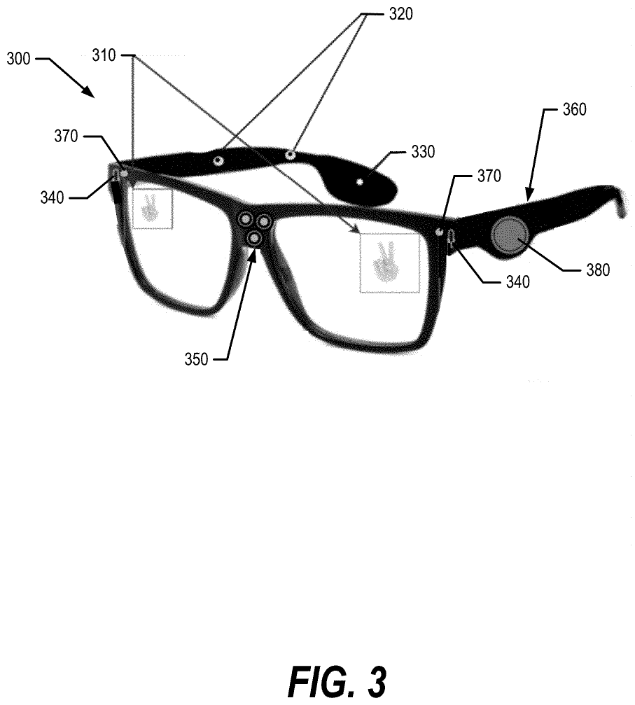

FIG. 3 is a depiction of a pair of smart glasses that are modified to provide a smart, seamless, sign language conversation device. Smart glasses 300 are equipped with a number of components used to provide a smart, seamless, sign language conversation device. These components include augmented reality-based glass 310 on which images (e.g., overlays, virtual reality information, etc.) can be displayed to the wearer of the glasses. EEG (electroencephalography) sensor 320 monitors electrical activity (voltage fluctuations resulting from ionic current) within the neurons of the user's brain to detect changes in the smart glass wearer's brain activity. Enclosed battery unit 330 provides power to smart glasses 300 and the various power-consuming components described herein. Microphone(s) 340 are used to converts sounds that reach the smart glasses into electrical signals that can then be further converted to text or otherwise used by components included in smart glasses 300 to aid the wearer of the smart glasses when communicating with another person or when receiving audible information, such as at a automated device. Camera units 350 are used to capture digital images of objects (e.g., people, signs, structures, etc.) which can be provided to smart glasses processing unit 360 that can, in one embodiment, provide artificial intelligence (AI) processing, machine learning (ML), and deep learning using one or more embedded processors. One or more speaker units 370 are included to provide audible signals from processing units 360. Finally, bone conduction earphone 380 conducts sound to the smart glass wearer's inner ear primarily through the bones in the wearer's skull that come in contact with the temples part of smart glasses 300. Bone conduction can convey sound to some users with hearing issues that might have difficulty hearing sound waves at the users' ears due to various forms of hearing loss.

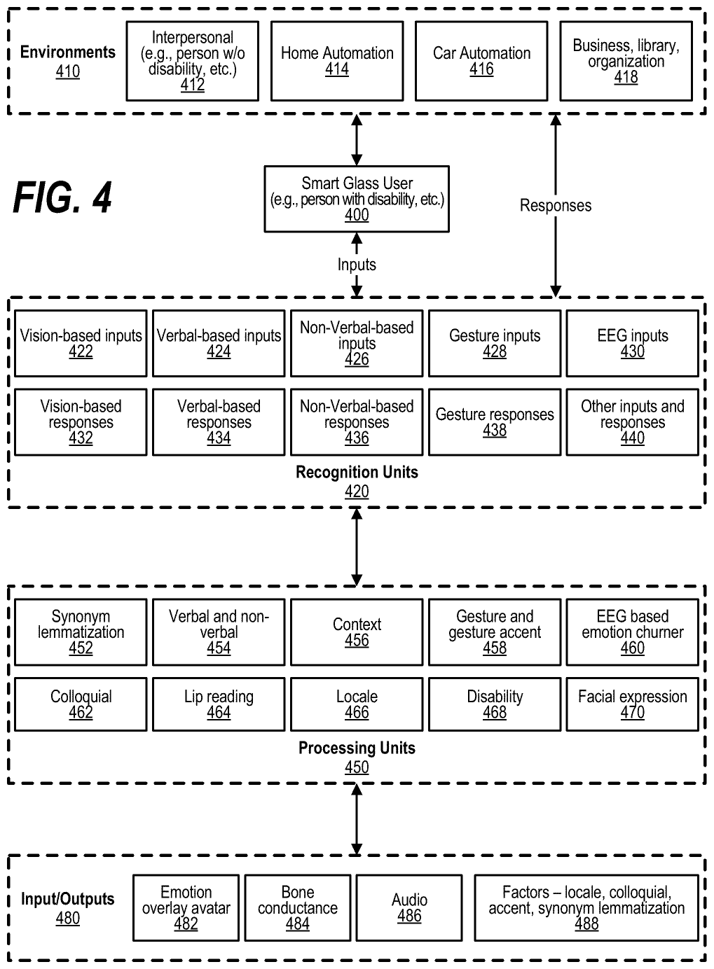

FIG. 4 is a depiction showing components used to provide a smart, seamless, sign language conversation device. Smart glass user 400 is, for example, a person with a hearing loss or other physical challenge that wishes to receive assistance from the smart glasses. Environments 410 are examples of various places, or environments, where the user might use the pair of smart glasses. Recognition units 420 are received at various components of the smart glasses as shown in FIG. 1. Processing units 450 depict the various types of processing that can be performed by the information handling system (e.g., processors, memory, programs, etc.) included in the smart glasses. Input/Output units 480 depict various inputs and outputs that can be received at and output to components found in the pair of smart glasses. The following describes the environments, recognition units, processing units, and I/O units included in the disclosed pair of smart glasses.

Sign language is a type of communicative gestures. Gestures recognition involves complex processes such as motion modeling, motion analysis, pattern recognition and machine learning The wearable smart Sign Language Glass embodiment device comprises of 1) Vision-based Camera Unit: One or More attached camera units along with Image and video recognition and processing units for continuous recognition of A) Hand Gestures recognition of SLC Communicator: which require the acquisition of images or video of the hand gestures through camera. Extraction of gesture trajectory using 1-a and 1-b B) Gestures of Opposite communicator (SLC Individual) C) Lip reading correlation Module to correlate response, of the SLC or Non SLC Responder D) Capturing Expressions of the SLC or Non SLC Responder. E) Events in the Environment. F) Scanning/reading any language Text/Image with its vision capabilities and gaze determination thereby auto converting that into sign language for people with deaf/dumb

2) Verbal and Non Verbal Voice aspect Microphone unit: One or More attached smart microphone units along with verbal and non-verbal vocal aspect for continuous recognition and processing of A) The Verbal and Non Verbal Voice aspects of communicator and the Opposite Individual (SLC Individual or Non) B) Reaction churner: from Vocal aspects of SLC communicator and responder ie different modulating nonverbal aspects of the speech of SLC communicator and SLC responder wherein we can utilize the nonverbal aspects of speech in order to make inferences about the emotional experience of the participants i.e. Grump, Excitement, Frustration etc. C) Vocal responses from the Non SLC Responder D) The Voice Normalization Unit: Many a times, partially or complete loss of hearing (by birth or accidental) can lead to adverse effect on Vocal pronunciations, Phonetics and modulations, hence the unit normalizes vocal text by understanding vocal pattern and reducing inflectional and derivational related forms of a word to a common base form for SLC communicator and SLC responder. E) Noise F) Environmental sound aspects

3) Sign Language gesture Spotting and Normalization unit: which takes inputs from #1 and subsequently processes and analyses the gestures using A) Variation Normalizer: We all know every SLC individual's hand gestures does differ from slight to marginal variation for the same Letter—combination of letters, same word—combination of words or same phrase—combination of phrases. The Normalization unit would understand gesture patterns and reducing inflectional & derivational related forms of a letter/word/phrase to a common base form. B) Speed normalizer: When comparing different samples of the same gesture, variations due to difference in gesturing speed should not contribute to the dissimilarity score. C) Sign Gesture Transition detector: Some times during consecutive gestures, A Sign gesture for the Letter —combination of letters, word—combination of words or phrase—combination of phrases melts/transitions into another Letter—combination of letters, word —combination of words or phrase D) combination of phrases wherein the transitions are usually observed in a sequence of finger gestures, where the end position of fingers associated with a gesture may not be the same as the starting position of fingers associated with the subsequent one. D) Sign Gesture Boundary Detection: A Sign gesture starts and ends with the hand staying in a standstill position for a while. That is, a signer generally starts making a sign from a “pause” state and ends in a “pause” state in case of continuous gesturing. Recognizing gesture pauses would help in separating parts of Sentences. Further pause states would be classified and mapped into corresponding Punctuation library. E) Simultaneous gesture detector: This detects Multiple Sign Gestures simultaneously for both the SLC Communicator as well as SLC responder.

4) EEG Sensor based Recognition unit: One or many EEG Sensors for capturing and analyzing Expressions of SLC communicator and SLC Responder and thereby determining reaction for a Letter or Word or phrase or sentence or any non-verbal vocal aspects, thereby enabling recognition of Ambiguous communications possibly innate socio-emotional concepts like Sarcasm, Sadness etc., but not limited to this, used by Sign language Individuals

5) A Microphone for capturing A) The Verbal and Non Verbal Voice aspects of communicator and the Opposite Individual (SLC Individual or Non) B) Reactions churner: from Vocal aspects of SLC communicator and responder ie different modulating nonverbal aspects of the speech of SLC communicator and SLC responder wherein we can utilize the nonverbal aspects of speech in order to make inferences about the reaction experience of the participants ie Grump, Excitement, Frustration etc., through wearable feed and voice analysis/gesture analysis only C) Vocal responses from the Non SLC Responder D) The Voice Normalization Unit: Many a times, partially or complete loss of hearing (by birth or accidental) can lead to adverse effect on Vocal pronunciations, Phonetics and modulations, hence the unit normalizes vocal text by understanding vocal pattern and reducing inflectional and derivational related forms of a word to a common base form for SLC communicator and SLC responder. E) Noise F) Environmental sound aspects

6) Intent/Context determiner Unit which spans responses from #1, #2 #3 and #4 to determine the particular linguistic constructional meaning of a Sign Language gesture i.e. Combination of A) Phrase or sentence from series of Sign Language Hand gestures B) Reactions from expressions responses during the delivery of particular Sign language phrase C) Reactions from Non-verbal vocal expressions through wearable feed and voice analysis/gesture analysis only D) Environmental sound aspects E) Events in the Environment.

7) Sign Language Synonym Lemmatization unit: As we all are aware several English words have same lexical synonyms for example, the word Angry and Mad are similar synonyms. Similarly sign language would have similar synonyms for various words, combination of words, sentences, combination of sentences. From the responses of #5 The Synonym Lemmatization unit would predict the simplest base form of synonym for a letter, word/combination of word, phrase/combination of phrase and generate a response that would be leveraged by all the future processing units in the proposed invention.

8) Sign language Translating Localization unit: Due to the co-existence of different sign languages, an effort must be endeavored to establish seamless communication between them. This can be accomplished by employing a Sign Language Translating Localization Unit. The system identifies the corresponding Sign Language by correlating the responses of #2 against a corpus/Knowledge Base/Library of all existing Sign Language. For example, if SLC Individual is gesturing in ASL, the System will Localize the Gestures by SLC to British Sign Language (BSL) by using a knowledge base library of all the available sign language translations.

9) Colloquialism analyzer Unit: which spans responses from #1-#8 and thereby auto understands regional and geography based informal words thereby storing a locale-based corpus and applying AI techniques to Translate and convert them into corresponding Sign language modulated gestures.

10) A smart speaker which converts the various inputs from #1-#8, of an SLC Communicator in real time and infuses a real output speech derived from the Voice, Tone and Various voice modulations of the SLC Communicator when communicating to a Non SLC Individual

11) A Sign Language response generator which analyses inputs from #1-#8 to replicate a moderately translucent augmented reality emotional expression powered Avatar on the Display Unit of Glass embodiment when receiving communication from a Locale based SLC Individual or a Non SLC Individual or any Physical Entity (Book, Traffic Instructions, Movie, Cricket commentary etc.)

12) A Smart bone conductance hearing Aid which identifies the depth/gravity of hearing loss and creates or amplifies verbal and non-verbal speech expressions from an SLC individual who have a partial hearing loss.

13) The Proposed system has the capability to automatically pair mobile with eye wearable and auto trigger the event base on the context identified.

14) The proposed system has the capability to dynamically create a Library for linguistic specific static sign words used by a sign language community like state/country/river/name etc. with respect to a particular linguistic identifier. The proposed eye glass embodiment has the capability of analyzing Sign Gesture Boundaries, Sign Gesture Transitions (corresponding expression and Nonverbal vocal aspects) between every combination of Letter or word or phrases or sentences thereby classifying and mapping the Gesture pause and transition states into corresponding Punctuation library (comma, dash, full stop, exclamation). The same capability can be leveraged in multiple gesturing for a seamless conversation

15) The capability to depict emotional expressions on the visual overlaid gesturing avatar of the glass embodiment or auditory voice command by analyzing the various assorted responses from the responder's conversation using techniques like animations analytics, graphic analytics.

16) The proposed system has the capability to scan/read through the image or text in any language with its vision/point of Gaze capabilities and dynamically translate the gazed content back in to the sign language as visual command overlay on the glass and/or into user native language and/or a voice command as well by the persons identified and classified disability using techniques like Gaze analytic.

17) When the sign language systems are designed, Digital Twins provide more better system and at real time AR/VR will provide real time data to improve product based on real users that are available.

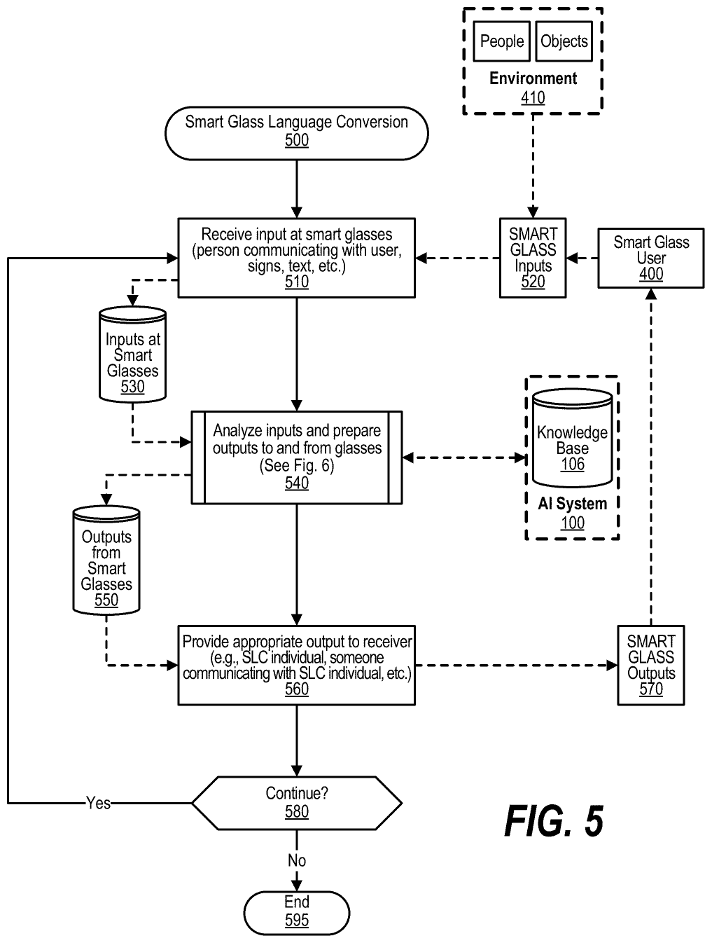

FIG. 5 is a depiction of a flowchart showing the logic used during a smart glass language conversation. FIG. 5 processing commences at 500 and shows the steps taken by a process that performs smart glass language conversion. At step 510, the process receives input at the smart glasses, such as from environment 410 or smart glass user 400 with inputs being received by smart glass inputs 520. Inputs can be received from a person communicating with the user, from signs, other text (verbal and nonverbal), and the like. The inputs received are stored in data store 530.

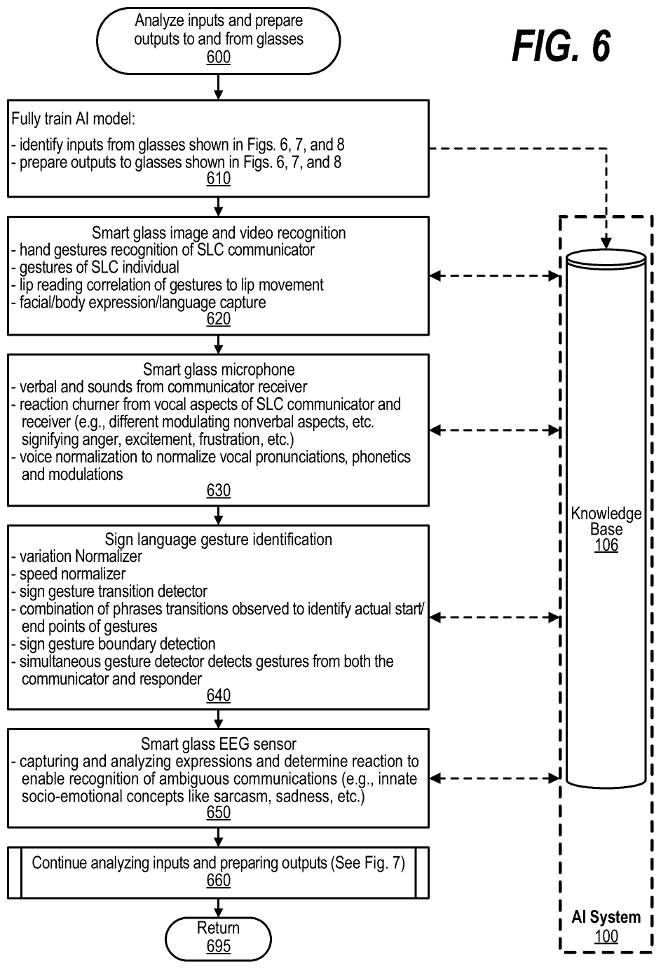

At predefined process 540, the process performs the Analyze inputs and Prepare Outputs routine (see FIG. 6 and corresponding text for processing details). This routine receives the inputs from data store 530 and interfaces with artificial intelligence (AI) system 100 that has trained models in knowledge base (corpus) 106 to detect, identify, and analyze inputs received at the smart glasses device. The routine stores the prepared outputs in data store 550.

At step 560, the process provides appropriate outputs to the receiver, such as an SLC individual, someone communicating with an SLC individual, and the like. The outputs are retrieved from data store 550 and delivered to the recipient through smart glass output components 570. As shown, smart glass outputs are also received by smart glass user 400 and may be used to generate further smart glass inputs, as described above.

The process determines as to whether to continue processing or terminate, depending on user actions (decision 580). If processing continues, then decision 580 branches to the ‘yes’ branch which loops back to step 510 to receive and process the next input received at the smart glass input components as described above. This looping continues until processing is terminated, at which point decision 580 branches to the ‘no’ branch exiting the loop and processing ends at 595.

FIG. 6 is a depiction of a flowchart showing the logic used to analyze inputs and prepare outputs to and from the smart glasses. FIG. 6 processing commences at 600 and shows the steps taken by a process that analyzes inputs received at smart glasses components and prepares outputs to transmit from smart glasses output components. At step 610, the process fully trains the AI model utilized by AI system 100 and stores the trained model in corpus 106. The trained model is able to identify the various inputs received at the glasses as shown in FIGS. 6, 7, and 8 as well as prepare outputs transmitted from the glasses also as shown in FIGS. 6, 7, and 8.

At step 620, the process performs smart glass image and video recognition using the trained model utilized by AI system 100. This includes hand gesture recognition of an SLC communicator, gestures of an SLC individual, lip reading correlation of gestures to lip movement, and capturing of facial and body expressions and language. This step, and each of the subsequent steps shown, use AI system 100 that utilizes a trained AI model to analyze inputs and prepare the outputs described in each step.

At step 630, the process performs smart glass microphone processing. This includes processing verbal noises and sounds from the communicator receiver, a reaction churner from vocal aspects of SLC communicator and the receiver. For example, identifying different modulating nonverbal aspects, etc. that signify things such as anger, excitement, frustration, and the like. Voice normalization is performed to normalize vocal pronunciations, phonetics and modulations for better understanding.

At step 640, the process performs sign language gesture identification. This includes a hand gesture variation normalizer, a hand gesture speed normalizer, a sign gesture transition detector, a detector of combinations of phrases and transitions observed to identify actual start and end points of gestures. Step 640 also includes sign gesture boundary detection, simultaneous gesture detector to detect gestures simultaneously given from both the communicator and the responder.

At step 650, the process processes the smarts glass EEG sensor. This includes capturing and analyzing expressions and determine the user's reaction to enable recognition of ambiguous communications. Ambiguous communications may include innate socio-emotional concepts such as sarcasm, sadness, and the like.

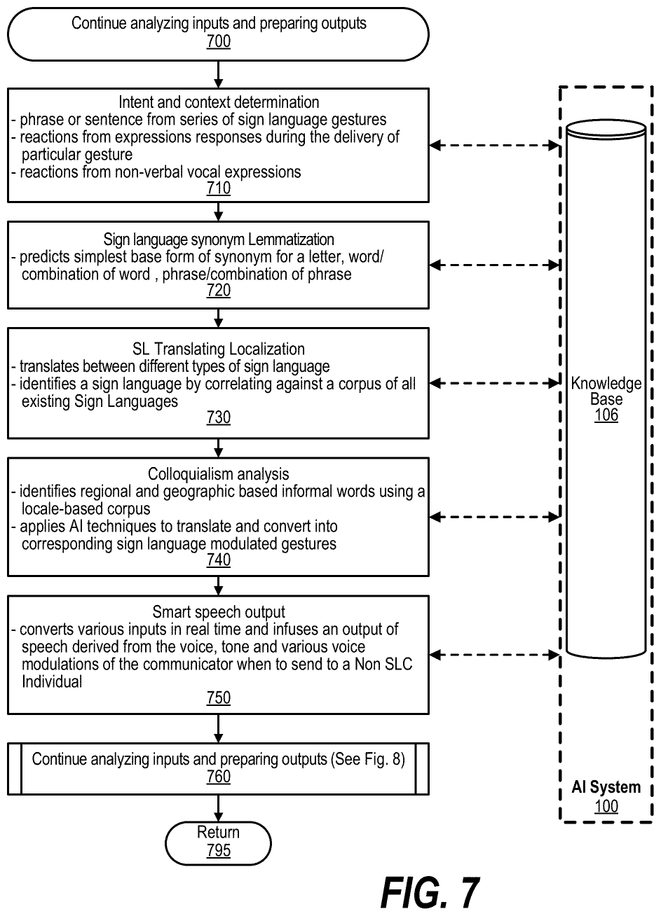

At predefined process 660, the process continues analyzing inputs and preparing outputs as shown in FIG. 7 (see FIG. 7 and corresponding text for processing details). FIG. 6 processing thereafter returns to the calling routine (see FIG. 5) at 695.

FIG. 7 is a continuation of the flowchart showing the logic used to analyze inputs and prepare outputs to and from the smart glasses. FIG. 7 processing commences at 700 whereupon, at step 710, the process performs intent and context determination. In this step, the intent and context of phrases or sentences from a series of sign language gestures is determined, the user's reactions from expressions and responses during the delivery of a particular gesture is determined for intent and context, and reactions from nonverbal vocal expressions are analyzed for intent and context determination. This step, and each of the steps shown, use AI system 100 that utilizes a trained AI model to analyze inputs and prepare the outputs described in each step.

At step 720, the process performs sign language synonym lemmatization. This step predicts the simplest base form of a synonym for a letter, word or word combination, or phrase or combination of phrases. At step 730, the process sign language translating localization. This step translates between different types of sign language. The step identifies a sign language by correlating against a corpus of all existing sign languages found in corpus 106.

At step 740, the process performs a colloquialism analysis. This step identifies regional and geographic based informal words using a locale-based corpus found in corpus 106. The step applies AI techniques performed by AI system 100 to translate and convert inputs into corresponding sign language modulated gestures.

At step 750, the process performs smart speech output processing. This step converts various inputs in real time and infuses an output of speech derived from the voice, tone and various voice modulations of the communicator and determines when to send the output to a non-SLC Individual.

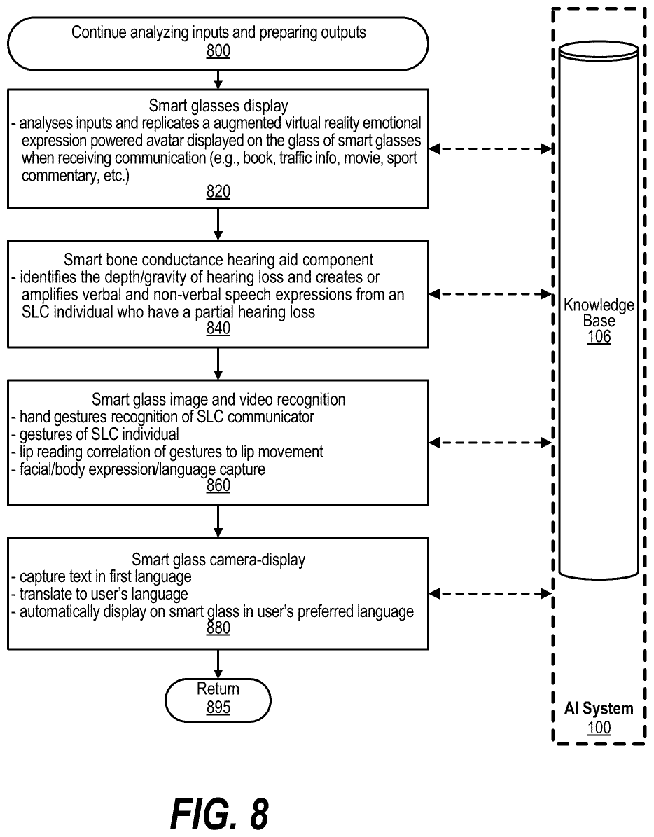

At predefined process 760, the process continues analyzing inputs and preparing outputs as shown in FIG. 8 (see FIG. 8 and corresponding text for processing details). FIG. 7 processing thereafter returns to the calling routine (see FIG. 6) at 795.

FIG. 8 is a further continuation of the flowchart showing the logic used to analyze inputs and prepare outputs to and from the smart glasses. Each of the steps shown in FIG. 8 use AI system 100 that utilizes a trained AI model to analyze inputs and prepare the outputs described in each step.

At step 820, the process performs the smart glasses display process. In this step, the process analyses inputs and replicates an augmented virtual reality emotional expression, such as one powered an avatar, that is then displayed on the transparent glass (lens) of the smart glasses when receiving communication. The communication can be from another person or from a book, traffic information, a movie, a sport commentary, and the like.

At step 840, the process smart performs bone conductance hearing aid component processing. This step identifies the depth and gravity of the user's hearing loss and creates or amplifies verbal and nonverbal speech expressions from an SLC individual who have a partial hearing loss. This created or amplified expression is communicated to the user via bone conductance earphone included in the temple portion of the smart glasses, as shown in FIG. 3.

At step 860, the process performs a smart glass image and video recognition process. This process includes identifying and recognizing hand gestures received at a digital camera included in the smart glasses, recognizing gestures of SLC individual received at the digital camera, recognizing lip movement (lip reading) received at the digital camera as well as the correlation of gestures received at the digital camera to such lip movement, and further capturing and recognizing facial and body expressions and language received at the digital camera included in the smart glasses.

At step 880, the process performs the smart glass camera process. This process captures text in a first language captured at a digital camera included in the smart glasses and translates the first language communication to the user's language. The translated data is automatically displayed on the smart glass (lens) in the user's preferred language. FIG. 8 processing thereafter returns to the calling routine (see FIG. 7) at 895.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method, implemented by an information handling system that includes a processor and a memory, the information handling system being included in a pair of smart glasses worn by a user, wherein the method comprises:
receiving a plurality of input cues at plurality of input components of the smart glasses, wherein one of the input components is an EEG sensor included in a temple portion of the pair of smart glasses, wherein one of the input components is a digital camera included in the smart glasses and accessible by the processor, and wherein one of the input components is a microphone included in the smart glasses and accessible by the processor;
receiving a selected one of the input cues at the EEG sensor, wherein the selected input cue emanates from the user of the pair of smart glasses;
analyzing the selected input cue using a trained artificial intelligence (AI) model, wherein the analyzing results in an emotional output cue;
generating an augmented reality output corresponding to the emotional output cue, wherein the augmented reality output includes an avatar corresponding to the emotional output cue;
analyzing the received cues, wherein the analyzing results in one or more output cues focused on assisting the user;
transmitting the output cues through one or more output components of the smart glasses, wherein one of the output components is a display on the inside of a lens included in the smart glasses; and
displaying the augmented reality output, including the avatar, on a transparent lens of the pair of smart glasses, wherein the displayed augmented reality output is visible to the user of the pair of smart glasses.

2. The method of claim 1 wherein one of the output components is a bone conductance earphone included in a temple portion of the pair of smart glasses, wherein the method further comprises:
transmitting at least one of the output cues to the user via the bone conductance earphone.

3. The method of claim 1 further comprising:
receiving a first of the plurality of input cues, wherein the first input cue is a first gesture communicated in a first sign language;
translating the first gesture from the first sign language to a second gesture corresponding to a second language that is understood by the user;
transmitting one of the output cues that corresponds to the second gesture through one of the output components.

4. (canceled)

5. (canceled)

6. The method of claim 1 further comprising:
receiving a verbal set of words at a microphone that is included in the pair of smart glasses;
translating the verbal set of words to a set of sign language representations; and
displaying the sign language representations on a transparent lens of the pair of smart glasses, wherein the displayed sign language representations is visible to the user of the pair of smart glasses.

7. The method of claim 1 wherein one of the output components is a bone conductance earphone included in a temple portion of the pair of smart glasses, wherein the method further comprises:
receiving a verbal set of words at a microphone that is included in the pair of smart glasses;
generating a set of bone conductance signals corresponding to the verbal set of words; and
transmitting the set of bone conductance signals to the user via the bone conductance earphone.

8. A pair of smart glasses that comprises an information handling system that further comprises:
one or more processors;
a memory coupled to at least one of the processors;
a set of computer program instructions stored in the memory and executed by at least one of the processors in order to perform actions comprising:
receiving a plurality of input cues at plurality of input components of the smart glasses, wherein one of the input components is an EEG sensor included in a temple portion of the pair of smart glasses, wherein one of the input components is a digital camera included in the smart glasses and accessible by the processor, and wherein one of the input components is a microphone included in the smart glasses and accessible by the processor;
receiving a selected one of the input cues at the EEG sensor, wherein the selected input cue emanates from the user of the pair of smart glasses;
analyzing the selected input cue using a trained artificial intelligence (AI) model, wherein the analyzing results in an emotional output cue;
generating an augmented reality output corresponding to the emotional output cue, wherein the augmented reality output includes an avatar corresponding to the emotional output cue;
analyzing the received cues, wherein the analyzing results in one or more output cues focused on assisting the user;
transmitting the output cues through one or more output components of the smart glasses, wherein one of the output components is a display on the inside of a lens included in the smart glasses; and
displaying the augmented reality output, including the avatar, on a transparent lens of the pair of smart glasses, wherein the displayed augmented reality output is visible to the user of the pair of smart glasses.

9. The information handling system of claim 8 wherein one of the output components is a bone conductance earphone included in a temple portion of the pair of smart glasses, wherein the actions further comprise:
transmitting at least one of the output cues to the user via the bone conductance earphone.

10. The information handling system of claim 8 wherein the actions further comprise:
receiving a first of the plurality of input cues, wherein the first input cue is a first gesture communicated in a first sign language;
translating the first gesture from the first sign language to a second gesture corresponding to a second language that is understood by the user;
transmitting one of the output cues that corresponds to the second gesture through one of the output components.

11. (canceled)

12. (canceled)

13. The information handling system of claim 8 wherein the actions further comprise:
receiving a verbal set of words at a microphone that is included in the pair of smart glasses;
translating the verbal set of words to a set of sign language representations; and
displaying the sign language representations on a transparent lens of the pair of smart glasses, wherein the displayed sign language representations is visible to the user of the pair of smart glasses.

14. The information handling system of claim 8 wherein one of the output components is a bone conductance earphone included in a temple portion of the pair of smart glasses, wherein the actions further comprise:
receiving a verbal set of words at a microphone that is included in the pair of smart glasses;
generating a set of bone conductance signals corresponding to the verbal set of words; and
transmitting the set of bone conductance signals to the user via the bone conductance earphone.

15. A computer program product stored in a computer readable storage medium, comprising computer program code that, when executed by an information handling system, performs actions comprising:
receiving a plurality of input cues at plurality of input components of the smart glasses, wherein one of the input components is an EEG sensor included in a temple portion of the pair of smart glasses, wherein one of the input components is a digital camera included in the smart glasses and accessible by the processor, and wherein one of the input components is a microphone included in the smart glasses and accessible by the processor;
receiving a selected one of the input cues at the EEG sensor, wherein the selected input cue emanates from the user of the pair of smart glasses;
analyzing the selected input cue using a trained artificial intelligence (AI) model, wherein the analyzing results in an emotional output cue;
generating an augmented reality output corresponding to the emotional output cue, wherein the augmented reality output includes an avatar corresponding to the emotional output cue;
analyzing the received cues, wherein the analyzing results in one or more output cues focused on assisting the user; transmitting the output cues through one or more output components of the smart glasses, wherein one of the output components is a display on the inside of a lens included in the smart glasses; and
displaying the augmented reality output, including the avatar, on a transparent lens of the pair of smart glasses, wherein the displayed augmented reality output is visible to the user of the pair of smart glasses.

16. The computer program product of claim 15 wherein one of the output components is a bone conductance earphone included in a temple portion of the pair of smart glasses, wherein the actions further comprise:
transmitting at least one of the output cues to the user via the bone conductance earphone.

17. The computer program product of claim 15 wherein the actions further comprise:
receiving a first of the plurality of input cues, wherein the first input cue is a first gesture communicated in a first sign language;
translating the first gesture from the first sign language to a second gesture corresponding to a second language that is understood by the user;
transmitting one of the output cues that corresponds to the second gesture through one of the output components.

18. (canceled)

19. The computer program product of claim 15 wherein the actions further comprise:
receiving a verbal set of words at a microphone that is included in the pair of smart glasses;
translating the verbal set of words to a set of sign language representations; and
displaying the sign language representations on a transparent lens of the pair of smart glasses, wherein the displayed sign language representations is visible to the user of the pair of smart glasses.

20. The computer program product of claim 15 wherein one of the output components is a bone conductance earphone included in a temple portion of the pair of smart glasses, wherein the actions further comprise:
receiving a verbal set of words at a microphone that is included in the pair of smart glasses;
generating a set of bone conductance signals corresponding to the verbal set of words; and
transmitting the set of bone conductance signals to the user via the bone conductance earphone.
